(19) United States
(12) Patent Application Publication
(10) Pub. No.: US 2009/0098490 A1
(43) Pub. Date: Apr. 16, 2009

(54) Radiation-Sensitive, Wet Developable Bottom Antireflective Coating Compositions and Their Applications in Semiconductor Manufacturing

(76) Inventors: Victor Pham, San Francisco, CA (US); Ramakrishnan Ayothi, Sunnyvale, CA (US); Mark Slezak, San Jose, CA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/974,946

(22) Filed: Oct. 16, 2007

(51) Int. Cl. G03C 5/56

(52) U.S. Cl. 430/327

(57) ABSTRACT

The present invention is directed to novel radiation-sensitive, wet developable bottom antireflective coating (DBARC) compositions and their use in semiconductor device manufacturing. The DBARC compositions contain a photoacid generator that produces a photoacid upon exposure to activating radiation. In a photolithographic imaging process, the relatively strong photoacid reduces or eliminates scumming. Further, the relatively large size of the photoacid limits its diffusion through the DBARC, thus minimizing or preventing undercut. The inventive method also limits diffusion of the photoacid by controlling the temperature of the post-exposure baking step. Use of the DBARC compositions with a photoresist in photolithography results in highly resolved features having essentially vertical profiles and no scumming and no undercut, which is critical as microelectronics and semiconductor components become increasingly miniaturized.

### BACKGROUND

1. Field of the Invention

The present invention is directed to compositions for forming radiation-sensitive, wet developable bottom antireflective coatings and their use in photolithographic semiconductor manufacturing.

2. Description of the State of the Art

The power and capabilities of computers and microelectronic devices have increased dramatically over the years as a result of semiconductor manufacturers' ability to place ever more transistors and other critical components on microsubstrates (e.g., integrated circuits). With the increasing miniaturization of electronics components, high-resolution photolithography requires better materials and technology.

Bottom antireflective coatings (BARCs) are used in semiconductor device manufacturing to reduce back reflection of light from reflective substrates. Back reflectivity can cause thin film interference (or standing waves) and reflective notching. Thin film interference results in changes in critical line width dimensions caused by variations in the total light intensity in the photoresist film as the thickness of the photoresist changes. Reflective notching becomes severe as the photoresist is patterned over substrates containing topographical features, which scatter light through the photoresist film, leading to line width variations and, in extreme cases, forming regions with complete photoresist loss. At shorter wavelengths, reflection from the substrate becomes increasingly detrimental to the lithographic performance of the photoresist.

The presence of a BARC below the photoresist diminishes the light interference that causes photoresist pattern degradation. The photoresist is typically removed in a wet development process using an aqueous base developing solution (e.g., tetramethyl ammonium hydroxide) after exposure to activating light. The BARC remains behind post-development due to the crosslinked nature of the BARC, which leads to the need for an etch step.

Certain steps in semiconductor device manufacturing, particularly the ion implantation step, are sensitive to the etch process. The sensitivities associated with the etch process have prompted alternative approaches, including the use of a dyed photoresist or a top antireflective coating. Neither of these approaches, however, is as effective as a BARC with respect to reflectivity control and, ultimately, critical dimension control.

To avoid the need for an etch step, photosensitive wet developable BARCs (DBARCs) have been developed. DBARCs can be imaged and developed along with the photoresist in the same wet development process. By eliminating the need for reactive ion etching, the use of wet developable BARCS reduces the cost and complexity of the semiconductor manufacturing process, increases throughput, and decreases the potential for device damage and defects.

Presently, trench scumming and line undercut pose an obstacle to the adoption of DBARCs in high-volume semiconductor manufacturing of critical device features of a size ≦130 nm. “Scumming” refers to the incomplete removal of BARC material from the trenches of photoresist patterns, and “undercut” refers to excessive lateral removal of BARC material such that small (e.g., ≦130 nm) photoresist lines are supported by much smaller BARC lines centered below them. In the wet development process with conventional DBARC systems, the DBARC is removed vertically at the same rate as horizontally, leading to undercutting of the photoresist lines. Such undercutting can result in line lifting and line collapse at smaller (<200 nm) sizes of photoresist lines.

Unlike conventional DBARC systems, the DBARC systems of the present invention minimize or eliminate both trench scumming and line undercut for isolated features ≦130 nm when the exposure dose is anchored in the dark field. Consequently, the present invention overcomes an obstacle precluding the use of DBARCs in high-volume, high-resolution semiconductor manufacturing.

### SUMMARY OF THE INVENTION

The present invention is directed to compositions for forming photosensitive, wet developable bottom antireflective coatings (DBARCs) and their applications in high-resolution, photolithographic semiconductor manufacturing. Among other inventive features, the invention reduces or eliminates scumming by utilizing a photoacid generator (PAG) that produces a sufficiently acidic photoacid upon exposure to activating radiation. Further, the invention minimizes or prevents undercutting by using a photoacid that is not too acidic and by controlling the rate and extent of anisotropic photoacid diffusion through the DBARC and photoresist. The invention controls the photoacid diffusion by using a photoacid of a certain minimum size and by controlling the temperature of a post-exposure baking step in the photolithographic process.

Some embodiments of the invention are directed to a composition for forming a bottom antireflective coating (BARC) capable of being developed in a base developer after exposure to activating radiation, the composition comprising:
an acid-labile polymer containing at least one acid-labile bond in its backbone or at least one acid-labile group, or
a photolabile polymer containing at least one photoreactive bond in its backbone, or
a cross-linkable polymer and a crosslinking agent, wherein the cross-linkable polymer contains a functional group capable of forming an acid-labile linkage with a functional group of the crosslinking agent;
a dye mixed in the composition or bonded to the acid-labile, photolabile or crosslinkable polymer;
a quencher; and
a photoacid generator (PAG) containing an imide or methide anion and an onium cation, wherein the anion has a molar volume of about 145 cm³/mol or greater.

In certain embodiments, the composition comprises a crosslinkable polymer and a crosslinking agent. In some embodiments, the linkage-forming functional group of the crosslinkable polymer is selected from carboxyl, hydroxyl, thiol and amino groups, and the linkage-forming functional group of the crosslinking agent is selected from vinyl ether, orthoester, ketal, acetal, ester, anhydride, carbonate, epoxy, and imine groups.

In one embodiment, the anion of the PAG has a molar volume of about 175 cm³/mol or greater. In another embodiment, the anion of the PAG has a molar volume of about 200 cm³/mol or greater.

The PAG is of formula (I)

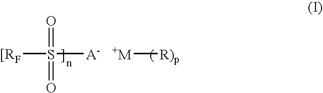

or of formula (II)

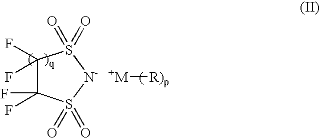

wherein:
A is N or C;
M is I or S;
each occurrence of R_{F} independently is straight or branched perfluoroalkyl or perfluorocycloalkyl, and optionally can have one or more substituents selected from straight or branched fluoroalkyl, straight or branched fluoroalkoxy, amino(fluoroalkyl), fluorocycloalkyl, fluoroheterocycloalkyl and fluoroaryl;
each occurrence of R independently is straight or branched alkyl, cycloalkyl, or aryl, and optionally can have one or more substituents selected from halogen atoms and straight or branched alkyl, straight or branched alkoxy, cycloalkyl, heterocycloalkyl, aryl, and acid-sensitive groups;
n is two when A is N and three when A is C;
p is two when M is I and three when M is S; and
q is an integer from 1 to 4.

In certain embodiments, the PAG is selected from diphenyliodonium, bis(4-t-butylphenyl)iodonium and triphenylsulfonium salts of bis(trifluoromethanesulfonyl)imide, bis(pentafluoroethanesulfonyl)imide, bis(nonafluorobutanesulfonyl)imide, tris(trifluoromethanesulfonyl)methide and cyclo(1,3-hexafluoropropanedisulfone)imidate, and combinations thereof.

In one embodiment, the PAG is in an amount from about 0.1% to about 25% by weight of the acid-labile, photolabile or cross-linkable polymer. In another embodiment, the PAG is in an amount from about 1% to about 3% by weight of the acid-labile, photolabile or cross-linkable polymer.

In certain embodiments, the quencher is selected from ammonium hydroxide, tetrabutylammonium hydroxide, trimethylsulfonium hydroxide, triphenylsulfonium hydroxide, n-octylamine, trioctylamine, diethanolamine, triethanolamine, 1-piperidine ethanol, N,N-dimethylformamide, pyridine-3-carboxamide, imidazole, 2-phenylpyridine, 2-phenylbenzimidazole, N,N,N′,N′-tetrakis-2-hydroxypropyl(ethylenediamine), bis(t-butylphenyl)iodonium cyclamate, tris(t-butylphenyl)sulfonium cyclamate, and combinations thereof.

In one embodiment, the quencher is in an amount from about 20% to about 80% by weight of the PAG. In another embodiment, the quencher is in an amount from about 20% to about 40% by weight of the PAG.

Further embodiments of the invention are drawn to a structure formed during a photolithographic process, the structure comprising:
a substrate, and
a layer of antireflective coating disposed over the substrate, wherein the coating is formed from any combination of embodiments of the inventive composition.

In other embodiments, the structure further comprises a layer of photoresist disposed over the layer of antireflective coating.

In some embodiments, the substrate comprises silicon, polysilicon, aluminum, germanium, tantalum, tungsten, tungsten silicide, gallium arsenide, tantalum nitride, silicon germanium, silicon oxide, silicon nitride, silicon oxide nitride, or a combination thereof.

Other embodiments of the invention are directed to a photolithographic method for producing a positive, high-resolution image having substantially vertical profiles with substantially no scumming and substantially no undercut, the method comprising:
applying any combination of embodiments of the inventive BARC composition to a substrate to form a layer of cured, hardened or crosslinked wet developable bottom antireflective coating (DBARC) over the substrate, wherein the cured, hardened or crosslinked DBARC is substantially insoluble in photoresist solvents and substantially insoluble in base developing solutions prior to exposure to activating radiation;
forming a layer of positive photoresist over the DBARC layer to form a photoimageable system;
disposing a mask over the photoresist layer;
exposing the system to activating radiation;
baking the system at a temperature from 90° C. to 115° C.; and
developing the system by contacting the photoresist layer and the DBARC layer with a base developing solution to remove the exposed areas of the photoresist layer and the exposed areas of the DBARC layer to produce a positive image on the substrate.

In some embodiments, the activating radiation is deep ultraviolet (DUV) radiation. In specific embodiments, the activating radiation is DUV radiation having a wavelength of 248 nm, or 193 nm, or 157 nm. In a particular embodiment, the activating radiation is 193 nm.

In certain embodiments, the post-exposure baking temperature is from 90° C. to 110° C. In a particular embodiment, the post-exposure baking temperature is about 110 C.

In one embodiment, the post-exposure baking occurs for about 45 seconds to about 90 seconds. In another embodiment, the post-exposure baking occurs for about 60 seconds to about 90 seconds.

Various embodiments of the invention are described in further detail below.

### BRIEF DESCRIPTION OF THE DRAWINGS

FIG. 1 shows a scanning electron micrograph (SEM) cross-sectional view of both dark field and bright field patterns without scumming or undercut as a result of the use of novel DBARC composition I and resist I.

FIG. 2 demonstrates that the use of novel DBARC composition I and resist II results in both dark field and bright field patterns without scumming or undercut.

FIG. 3 shows that the use of conventional DBARC composition III and resist I causes both scumming of dark field trench features and undercut of bright field features.

FIGS. 4(a)-(c) demonstrate that the use of conventional DBARC composition III causes pattern collapse for isolated resist lines, unlike the use of novel DBARC compositions I and II.

### DEFINITIONS OF TERMS

The following definitions apply:

An “acid-labile” bond or linkage is one whose structural integrity is affected by its reaction with an acid. Reaction of the bond or linkage with the acid typically results in cleavage of the bond or linkage. Similarly, reaction of an “acid-labile” or “acid-sensitive” group with an acid typically leads to decomposition of the group or its transformation into another chemical group. Functionalities (e.g., acetals, esters, etc.) that are acid-labile as bonds or linkages generally are also acid-labile as groups. The lability of an acid-labile bond, linkage or group can be affected (and modulated) by various factors, such as the strength and amount of the acid and the temperature and duration of the reaction of the bond, linkage or group with the acid.

Non-limiting examples of acid-labile bonds or linkages and acid-labile, or acid-sensitive, groups include orthoester, ketal, acetal, ester, thioester, anhydride, carbonate, sulfonamide, sulfonate, sulfate, imine, oxime, ether, and thioether.

A substance or material is “substantially insoluble” in a solvent system if less than about 25% of the substance or material by mass dissolves in that solvent system. In certain embodiments, “substantially insoluble” means that less than about 20%, or less than about 15%, or less than about 10%, or less than about 5% of the substance or material by mass dissolves in the solvent system.

A substance or material is “substantially soluble” or “substantially dissolves” in a solvent system if more than about 75% of the substance or material by mass dissolves in that solvent system. In certain embodiments, “substantially soluble” or “substantially dissolves” means that more than about 80%, or more than about 85%, or more than about 90%, or more than about 95% of the substance or material by mass dissolves in the solvent system.

“Substantially no scumming” means that there is no closing or bridging of spaces due to unremoved DBARC residue after wet development. “Scumming” exists when DBARC residue is visible in trenches (e.g., under-top-down or cross-section SEM) at the exposure dose to achieve target feature size or a higher exposure dose.

“Substantially no undercut” means that there is no apparent lateral development rate mismatch between the resist and DBARC. In some embodiments, “substantially no undercut” means that at least 95% of the horizontal dimension of unexposed resist lines or areas is supported by DBARC lines or areas below them.

A “substantially vertical” profile or feature is a resist profile or feature that has sides at greater than 85°. In certain embodiments, a “substantially vertical” profile or feature has sides at greater than 88°, or greater than 91°, or greater than 94°, or greater than 97°.

A “high-resolution” image is able to print sub-150 nm isolated lines and spaces simultaneously. In some embodiments, a “high-resolution” image is able to print sub-130 nm, or sub-100 nm, isolated lines and spaces simultaneously.

A material (e.g., a coating) that is disposed or formed “over” a substrate can be deposited directly or indirectly over at least a portion of the surface of the substrate. Direct depositing means that the material is applied directly to the exposed surface of the substrate. Indirect depositing means that the material is applied to another, intervening material that has been deposited directly or indirectly over the substrate.

The “exposed areas” of an antireflective coating can refer to those areas of the coating directly exposed to an activating radiation as well as those areas of the coating adjacent to the exposed areas of the photoresist that is substantially transparent to the activating radiation.

An antireflective coating “adjacent” to a photoresist can be directly adjacent to the photoresist or can be separated from the photoresist by an intermediate layer of inert polymer.

The terms “photoresist” and “resist” are used interchangeably herein.

A “dye” is a substance or chemical group that absorbs light at a particular wavelength or in a particular range of wavelengths. The dye can be a free dye or physically or chemically attached to another substance or material. One of ordinary skill in the art would understand that the terms “dye” and “chromophore” can be used interchangeably in appropriate situations.

The terms “halogen”, “halo”, “halide” and the like refer to fluoride, chloride, bromide and iodide.

The term “alkyl” refers to an optionally substituted, straight-chain or branched hydrocarbon moiety. Examples of alkyl groups include, but are not limited to, methyl, ethyl, n-propyl, isopropyl, n-butyl, isobutyl, sec-butyl, tert-butyl, n-pentyl, and isopentyl.

The term “alkoxy” refers to an alkyl group that contains at least one divalent oxygen other than a hydroxyl group. The divalent oxygen can be attached to the main body of the compound and to a carbon atom in the alkyl group, or to two carbon atoms in the alkyl group. Further, the divalent oxygen can be in the main portion of the alkyl group or in a side group thereof.

The term “cycloalkyl” refers to an optionally substituted, mono- or polycyclic hydrocarbon moiety. Examples of cycloalkyl groups include, but are not limited to, cyclopropyl, cyclobutyl, cyclopentyl, cyclohexyl, and norbornyl.

The term “heterocycloalkyl” refers to a cycloalkyl group in which at least one ring in the cyclic moiety contains one or more heteroatoms selected from O, S, and N. Non-limiting examples of heterocycloalkyl groups include aziridinyl, oxiranyl, pyrrolidinyl, piperidinyl, piperazinyl, 1,4-dioxanyl, and morpholinyl.

The term “aryl” refers to an optionally substituted, mono- or polycyclic aromatic moiety in which at least one ring in the moiety is aromatic. The aryl group may contain one or more non-aromatic (saturated or unsaturated) rings. The aromatic ring is carbocyclic, but the non-aromatic ring may contain one or more heteroatoms selected from O, S, and N. Examples of aryl groups include, but are not limited to, phenyl, indolinyl, 2,3-dihydrobenzofuryl, 2,3-dihydrobenzothiophene, chromanyl, 1,2,3,4-tetrahydroquinolinyl, naphthyl, and indanyl.

The term “heteroaryl” refers to an aryl group in which at least one aromatic ring in the aromatic moiety contains one or more heteroatoms selected from O, S, and N. Non-limiting examples of heteroaryl groups include pyrrolyl, furyl, isoxazolyl, oxazolyl, thiophenyl, thiazolyl, isothiazolyl, pyridyl, indolyl, benzofuranyl, benzothiophenyl, quinolinyl, and isoquinolinyl.

A “haloalkyl” group is an alkyl group that contains one or more halogen atoms. For example, a “fluoroalkyl” group is an alkyl group that contains one or more fluorine atoms. Likewise, a “haloalkoxy” (e.g., a “fluoroalkoxy”) group is an alkoxy group that contains one or more halogen (e.g., fluorine) atoms, a “halocycloalkyl” (e.g., a “fluorocycloalkyl”) group is a cycloalkyl group that contains one or more halogen (e.g., fluorine) atoms, and so on.

An “amino(fluoroalkyl)” group is an amino group that contains one or two fluoroalkyl groups. The fluoroalkyl group(s) can be straight or branched. If the amino group contains two fluoroalkyl groups, the fluoroalkyl groups can be the same or different.

A “perfluoroalkyl” or a “perfluorocycloalkyl” group is an alkyl or a cycloalkyl group in which all the hydrogen atoms are replaced with fluorine atoms. For example, a perfluorobutyl group is nonafluorobutyl, and a perfluorocyclopropyl group is pentafluorocyclopropyl.

An alkyl, alkoxy, cycloalkyl, heterocycloalkyl, aryl or heteroaryl group may be substituted or unsubstituted. If substituted, it can contain from 1 to 5 substituents selected from, among others, halogen atoms and alkyl, alkoxy, haloalkyl, haloalkoxy, cycloalkyl, heterocyloalkyl, aryl, heteroaryl and acid-sensitive groups.

### DETAILED DESCRIPTION OF THE INVENTION

The combination of bright and dark field exposure is required for several levels of semiconductor device manufacturing by photolithography. The light intensity produced from bright field exposure and dark field exposure differs, and this difference is directly translated into photoacid generation. Photosensitive DBARCs are sensitive to the chemical components present in their formulation, the resist processing conditions, and the set of exposure conditions used in the photolithography process. A resist/DBARC system that gives high-resolution images with vertical sidewalls after wet development is an important requirement for a robust semiconductor manufacturing process. In addition, the resist/DBARC system should have an acceptable process window. Unlike conventional DBARC systems, the DBARC systems of the present invention are capable of providing high-resolution images having essentially vertical profiles with no scum and no undercut, which demonstrates their suitability for a robust semiconductor manufacturing process.

Conventional photoresist/DBARC systems fail to print features ≦130 nm at various pitches simultaneously in both bright and dark fields without scumming or undercut defects. If the exposure dose is set to resolve 140 nm trench/420 nm pitch using 560 nm trench/1680 nm pitch mask feature (4×) in the dark field (“anchor condition”), isolated photoresist lines in conventional photoresist/DBARC systems collapse due to undercut for all line features ≦140 nm in the bright field. Post-exposure bake adjustments within ±15° C. around conventional photoresist/DBARC bake conditions do not improve overall performance.

Wet development of conventional resist/DBARC systems containing no photosensitive component or containing only a quencher results in trench scumming but no line undercut. On the other hand, wet development of conventional resist/DBARC systems containing a quencher and a small quantity of a PAG yields less scum in the trenches, but also undercut of isolated resist lines.

Furthermore, the dissolution properties of conventional resist/DBARC systems in typical aqueous alkaline resist developers differ between dark field and bright field features. While isolated resist lines in the bright field suffer from undercut, trenches in the dark field only scum less. Photoacid generation from a PAG after exposure to activating radiation and the deprotection reactions that promote solubility of the DBARC in the developer proceed to a greater extent in the bright field. With conventional resist/DBARC systems, the deprotection reactions, rather than photoacid diffusion, appear to be the limiting factor, as evidenced by: (1) some scumming in the dark field (not enough photoacid), and (2) lateral undercut beneath photoresist lines that reduces ˜140 nm of DBARC to only several nanometers (too much photoacid).

By making photoacid diffusion the limiting factor, the resist/DBARC systems of the present invention achieve similar profiles simultaneously for dark field and bright field features despite different concentrations of generated photoacid. In other words, by making the resist/DBARC system acid diffusion-limited, the present invention minimizes or eliminates undercut by containing photoacid diffusion. A sufficiently strong photoacid or a PAG with high quantum efficiency can effectively perform the deprotection reactions to solubilize the acid-labile DBARC in all dark field and bright field features.

The present invention minimizes or prevents undercut of resist lines by using a photoacid of appropriate acidity and by limiting the diffusion of the photoacid through the DBARC and resist. Conventional resist/DBARC systems employ PAGs that generate perfluoroalkylsulfonic acids. Lower perfluoro(C₁-C₄)alkylsulfonic acids are too strong acids and diffuse excessively because of their smaller size, and consequently cause undercut of resist lines. Higher perfluoroalkylsulfonic acids having six or more carbon atoms are known to be both environmentally persistent and toxic. Perfluoropentylsulfonic acid is environmentally persistent and also possibly toxic.

Unlike the perfluoroalkylsulfonic acids used in conventional resist/DBARC systems, the imide and methide PAGs of the invention generate photoacids of appropriate acidity. The photoacids of the invention are sufficiently acidic to minimize or prevent scumming. At the same time, the photoacids used in the inventive resist/DBARC system are not so strongly acidic as to cause undercut of resist lines.

Further, the present invention controls and limits the diffusion of the photogenerated photoacid through the DBARC and photoresist layers in two ways. First, photoacid diffusion is controlled by employing a PAG whose anion meets a certain minimum molar volume. The bigger and bulkier the photoacid, the less extensively and the more slowly it diffuses through a polymeric material.

Second, photoacid diffusion is controlled by using the appropriate temperature during the post-exposure baking step. Post-exposure baking facilitates deprotection reactions in the photoresist and DBARC, which render these materials soluble in typical aqueous base photoresist developing solutions. By using a photoacid of sufficient molar volume and the appropriate post-exposure bake (PEB) temperature, the invention effectively reduces photoacid diffusion during the deprotection reaction process, thereby minimizing or preventing undercut of photoresist lines.

Conventional resist/DBARC systems produce uneven removal of the DBARC by the resist developer between bright field and dark field features, and produce undercut profile resulting from acid diffusion in the bright field. By contrast, the DBARC composition of the invention comprises a PAG whose anion has adequate molar volume. Diffusion of the sufficiently large, photogenerated photoacid under the appropriate PEB temperature is effectively controlled and limited. Consequently, the use of the inventive DBARC composition with commercially available photoresists produces high-resolution images having essentially vertical profiles and scum and undercut within an acceptable process window under both dark field and bright field exposure.

The present invention can be better understood in view of various, non-limiting embodiments of the invention, as described below.

### Embodiments of the Invention

Composition and Antireflective Coating

Some embodiments of the invention are directed to a composition for forming a bottom antireflective coating (BARC) capable of being developed in a base developer after exposure to activating radiation, the composition comprising:
an acid-labile polymer containing at least one acid-labile bond in its backbone or at least one acid-labile group, or
a photolabile polymer containing at least one photoreactive bond in its backbone, or
a cross-linkable polymer and a crosslinking agent, wherein the cross-linkable polymer contains a functional group capable of forming an acid-labile linkage with a functional group of the crosslinking agent;
a dye mixed in the composition or bonded to the acid-labile, photolabile, or crosslinkable polymer; and
a photoacid generator (PAG) containing an imide or methide anion and an onium cation, wherein the anion has a molar volume of about 145 cm³/mol or greater.

The DBARC composition can comprise one or more PAGs. In another embodiment, the DBARC composition further comprises a quencher. In yet another embodiment, the DBARC composition further comprises a solvent system.

It is understood that in the present invention, either the anion of the PAG or the corresponding photoacid has a molar volume of about 145 cm³/mol or greater. In certain embodiments, optionally in combination with one or more other embodiments described herein, the anion of the PAG, or the corresponding photoacid, has a molar volume of at least about 175 cm³/mol, or at least about 200 cm³/mol, or at least about 225 cm³/mol, or at least about 250 cm³/mol.

Photoacid Generator (PAG)

The BARC composition of the invention comprises a PAG of formula (I)

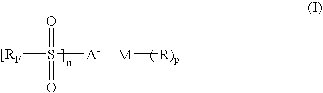

or of formula (II)

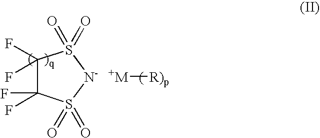

wherein:
A is N or C;
M is I or S;
each occurrence of R_{F} independently is straight or branched perfluoroalkyl or perfluorocycloalkyl, and optionally can have one or more substituents selected from straight or branched fluoroalkyl, straight or branched fluoroalkoxy, amino(fluoroalkyl), fluorocycloalkyl, fluoroheterocycloalkyl and fluoroaryl;
each occurrence of R independently is straight or branched alkyl, cycloalkyl, or aryl, and optionally can have one or more substituents selected from halogen atoms and straight or branched alkyl, straight or branched alkoxy, cycloalkyl, heterocycloalkyl, aryl, and acid-sensitive groups;
n is two when A is N and three when A is C;
p is two when M is I and three when M is S;
q is an integer from 1 to 4; and
the anion of the PAG of formula (I) or formula (II) has a molar volume of about 145 cm³/mol or greater.

In certain embodiments, the heterocycloalkyl substituents on the R groups of the PAG cation can have one or more oxygen and/or sulfur atoms, but no nitrogen atom, in their ring system. U.S. Pat. Nos. 5,514,493 and 5,874,616 describe non-limiting examples of substituted and unsubstituted fluoroalkylsulfonyl imides and methides and their preparation.

To limit photoacid diffusion, and thus minimize or prevent undercut, it is important that the anion of the PAG (or the corresponding photoacid) has a certain minimum molar volume. The larger or bulkier the photoacid, the less extensively and the more slowly it diffuses through a polymeric material (e.g., a DBARC or a resist). The anion of the PAG can be made bulkier by, e.g., using larger or more branched chemical groups. In certain embodiments, optionally in combination with one or more other embodiments described herein, the anion of the PAG, or the corresponding photoacid, has a molar volume of at least about 145 cm³/mol, or at least about 175 cm³/mol, or at least about 200 cm³/mol, or at least about 225 cm³/mol, or at least about 250 cm³/mol.

In certain embodiments, optionally in combination with one or more other embodiments described herein, the PAG is selected from:
diphenyliodonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
bis(4-t-butylphenyl)iodonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
triphenylsulfonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
and combinations thereof.

In a more specific embodiment, optionally in combination with one or more other embodiments described herein, the PAG is selected from bis(4-t-butylphenyl)iodonium bis(trifluoromethanesulfonyl)imide, bis(4-t-butylphenyl)iodonium tris(trifluoromethanesulfonyl)methide, triphenylsulfonium bis(trifluoromethanesulfonyl)imide, triphenylsulfonium tris(trifluoromethanesulfonyl)methide, and combinations thereof.

In some embodiments, optionally in combination with one or more other embodiments described herein, the PAG specifically cannot be any one of the PAGs described herein. In an embodiment, the PAG cannot be diphenyliodonium bis(trifluoromethanesulfonyl)imide, diphenyliodonium tris(trifluoromethanesulfonyl)methide, triphenylsulfonium bis(trifluoromethanesulfonyl)imide, triphenylsulfonium tris(trifluoromethanesulfonyl)methide, or homologs thereof.

The PAG of the invention absorbs at the wavelength of the radiation used to expose the photoresist and DBARC. Without being bound by theory, it is believed that when the onium cation of the PAG absorbs the activating radiation, the PAG is photolysed, resulting in separation of the anion and cation components of the PAG. The anion then extracts a proton from the environment, generating the photoacid that catalyzes deprotection reactions in the exposed areas of the DBARC.

In some embodiments, optionally in combination with one or more other embodiments described herein, the PAG absorbs radiation from about 100 nm to about 350 nm. In other embodiments, the PAG absorbs deep ultraviolet (DUV) radiation, i.e., from about 100 nm to about 300 nm. In further embodiments, the PAG absorbs radiation from about 150 nm to about 250 nm. In specific embodiments, the PAG absorbs at 248 nm, or at 193 nm, or at 157 nm. For a photoresist and DBARC that are developed for 193 nm exposure, examples of PAGs that absorb at 193 nm include, but are not limited to, diphenyliodonium imides and methides, dialkyliodonium imides and methides, triphenylsulfonium imides and methides, and trialkylsulfonium imides and methides. Non-limiting examples of PAGs that absorb at 248 nm include diphenyliodonium imides and methides and triphenylsulfonium imides and methides.

The quantity of the PAG in the inventive composition is selected to achieve effective deprotection reactions in the DBARC to eliminate scumming, while minimizing or preventing undercut. In some embodiments, optionally in combination with one or more other embodiments described herein, the PAG is in an amount from about 0.1% to about 25% by weight of the acid-labile, photolabile or cross-linkable polymer. In narrower embodiments, the PAG is in an amount from about 0.1% to about 20%, or from about 0.1% to about 15%, or from about 1% to about 10%, or from about 1% to about 5%, or from about 1% to about 3% by weight of the acid-labile, photolabile or cross-linkable polymer.

Acid-Labile Photolabile and Crosslinkable Polymers, Crosslinking Agent and Dye

The DBARC composition of the invention comprises a polymer that is known to be useful for a wet developable BARC (DBARC) and that contains at least one acid-labile group or at least one acid-labile bond or photolabile bond, either in its backbone or formed by reaction with a crosslinking agent. The components of the DBARC composition are selected such that the DBARC has good absorption characteristics to prevent line width variations (or standing waves) and reflective notching at the desired exposure wavelength.

In some embodiments, optionally in combination with one or more other embodiments described herein, the DBARC composition comprises an acid-labile polymer containing at least one acid-labile bond in its backbone. In certain embodiments, the at least one acid-labile bond in the backbone of the acid-labile polymer is selected from orthoester, ketal, acetal, ester, thioester, anhydride, carbonate, sulfonamide, sulfonate, sulfate, imine, oxime, ether and thioether bonds, and combinations thereof. To facilitate deprotection (i.e., cleavage) of ester, thioester, ether and thioether bonds and the like in the presence of a photoacid, polymers containing tertiary rather than primary ester, thioester, ether and thioether bonds and the like can be used.

In other embodiments, optionally in combination with one or more other embodiments described herein, the DBARC composition comprises an acid-labile polymer containing at least one acid-labile group. In one embodiment, the at least one acid-labile group is a pendant group. The polymer without at least one acid-labile group is soluble in a base developer due to the presence of at least one hydrophilic functionality, but becomes insoluble in a base developer (and in a photoresist solvent) when the at least one hydrophilic functionality is protected as an acid-labile group. Examples of hydrophilic functionalities include, but are not limited to, carboxyl, hydroxyl, thiol and amino groups. Non-limiting examples of monomers that impart solubility in a base developer are acrylic acid, methacrylic acid, vinyl alcohol, hydroxystyrenes, and vinyl monomers containing 1,1′,2,2′,3,3′-hexafluoro-2-propanol. Other kinds of monomer containing a group that makes the unprotected polymer soluble in a base developer can also be used.

The hydrophilic functionalities of monomeric units can be protected as acid-labile groups to render the polymer insoluble in photoresist solvents and base developers. Non-limiting examples of acid-labile groups include orthoester, ketal, acetal, ester, thioester, anhydride, carbonate, sulfonamide, sulfonate, sulfate, imine, oxime, ether, thioether, and epoxy. To facilitate deprotection of ester, thioester, ether and thioether groups and the like in the presence of a photoacid, polymers containing tertiary rather than primary ester, thioester, ether and thioether groups and the like can be used.

In some embodiments, the acid-labile groups are selected from —CO₂R, —OR, —OC(O)OR, —C(CF₃)₂OR, —C(CF₃)₂OC(O)OR, and —C(CF₃)₂CO₂R, where R is selected from optionally substituted alkyl, optionally substituted cycloalkyl, oxocyclohexyl, lactone, optionally substituted benzyl, silyl, alkyl silyl, alkoxyalkyl (e.g., ethoxyethyl and methoxyethoxyethyl), acetoxyalkoxyalkyl (e.g., acetoxyethoxyethyl), tetrahydrofuranyl, methyl adamantyl, menthyl, tetrahydropyranyl and mevalonic lactone. Non-limiting examples of R include t-butyl, t-butoxycarbonyl tricycle[5.3.2.0]decanyl, 2-methyl-2-adamantyl, 3-hydroxy-1-adamantyl, 2-methyl-2-adamantyl, isobornyl, norbornyl, adamantyloxyethoxyethyl, menthyl, tetrahydropyranyl, 3-oxocyclohexyl, β-(γ-butyrolactonyl), and mevalonic lactone. Non-limiting examples of monomers containing acid-labile groups include vinyl compounds containing the aforementioned acid-labile groups.

Any acid-labile group that can be cleaved with an imide- or methide-derived photoacid can be attached to the polymer. In the presence of a photoacid, the acid-labile group is cleaved, yielding the unprotected hydrophilic functionality that renders the polymer soluble in a base developer. Protected monomers may be polymerized to give homopolymers or with other protected monomers to give copolymers. Alternatively, the hydrophilic functionalities of a base developer-soluble homopolymer or copolymer can be protected in the form of acid-labile groups. U.S. Pat. No. 6,844,131 describes acid-labile polymers containing acid-labile groups, whether derived from monomers containing hydrophilic functionalities or from monomers containing acid-labile groups.

In yet other embodiments, optionally in combination with one or more other embodiments described herein, the DBARC composition comprises a photolabile polymer containing at least one photoreactive bond in its backbone. The photolabile polymer contains a chromophore group that absorbs at the exposure wavelength of the imaging process. Absorption of the exposure radiation by the chromophore leads to chemical changes in and the breaking down of the photoreactive bonds. The light-activated photoreactive bonds can also react with an acid (e.g., the photoacid generated by the PAG that absorbs at the exposure wavelength), resulting in the breaking down of the bonds. The broken down polymeric products contain functional groups (e.g., sulfonic acid, hydroxyl, etc.) that render them soluble in a base developing solution. Non-limiting examples of photolabile polymers containing photoreactive bonds in their backbone include the polycarbonates, polysulfonyl esters, polycarbonate-sulfones, polysulfonylester oximes, and polysulfonylester imines disclosed in U.S. Pat. No. 7,108,958.

In further embodiments, optionally in combination with one or more other embodiments described herein, the DBARC composition comprises a cross-linkable polymer and a crosslinking agent, wherein the cross-linkable polymer contains a functional group capable of forming an acid-labile linkage with a functional group of the crosslinking agent. In some embodiments, an oligomer containing a functional group capable of forming an acid-labile crosslinkage, rather than or in addition to a crosslinkable polymer, can be used to form the BARC. The crosslinkable polymer or oligomer can contain one or more functional groups capable of forming one or more acid-labile linkages with one or more functional groups of the crosslinking agent.

In some embodiments, optionally in combination with one or more other embodiments described herein, the linkage-forming functional group of the crosslinkable polymer or oligomer is selected from carboxyl, hydroxyl, thiol and amino groups, and the linkage-forming functional group of the crosslinking agent is selected from vinyl ether, orthoester, ketal, acetal, ester, anhydride, carbonate, epoxy, and imine groups. In a particular embodiment, the linkage-forming functional group of the crosslinkable polymer or oligomer is carboxyl or hydroxyl, and the linkage-forming functional group of the crosslinking agent is vinyl ether. To facilitate deprotection (i.e., cleavage) of ester, thioester, ether and thioether crosslinkages and the like in the presence of a photoacid, crosslinkable polymers or oligomers and crosslinking agents forming tertiary rather than primary ester, thioester, ether and thioether crosslinkages and the like can be used.

Carboxyl, hydroxyl and thiol groups, and to a lesser extent an amino group, allow the cleaved DBARC polymer (the regenerated crosslinkable polymer) to be soluble in a base developer after the acid-labile linkages are cleaved in the presence of the photogenerated photoacid. Cleavage (or “decrosslinking”) of the crosslinkages also renders the crosslinking agent component of the DBARC polymer soluble or substantially soluble in a base developer. For example, if the crosslinkable polymer has a carboxyl group and the crosslinking agent has a vinyl ether group, crosslinkage between them forms an acetal linkage. Photoacid-catalyzed cleavage of the acetal linkage regenerates the carboxyl group on the crosslinkable polymer and yields acetaldehyde (formed from water and the vinyl functionality of the crosslinking agent) and the crosslinking agent having a hydroxyl group (from the ether functionality).

Alternatively, the linkage-forming functional group of the crosslinkable polymer or oligomer is selected from vinyl ether, orthoester, ketal, acetal, ester, anhydride, carbonate, epoxy, and imine groups, and the linkage-forming functional group of the crosslinking agent is selected from carboxyl, hydroxyl, thiol and amino groups. Cleavage of the acid-labile crosslinkage in the presence of the photogenerated photoacid may result in a functional group on the crosslinkable polymer that renders the polymer soluble in a base developing solution, or that may itself react with the base developing solution to form another functional group on the polymer that renders the polymer soluble in the developing solution.

Non-limiting examples of cross-linkable polymers include:
polymers derived from monomers containing hydroxyl and/or carboxyl groups, as described in US 2005/0214674;
polymers and oligomers containing carboxyl groups as described in US 2007/0117049;
polymers derived from monomers containing a hydroxyl group, as disclosed in Fu et al., Proc. SPIE, vol. 4345, p. b751 (2001); and
polymers derived from monomers containing an acetal functionality, as described in GB 2,354,763 A and U.S. Pat. No. 6,322,948.

Examples of crosslinking agents include, but are not limited to:
vinyl ether-terminated crosslinking agents as described in US 2005/0214674 and US 2007/0117049; and
silicon-containing enol ether crosslinking agents as disclosed in U.S. Pat. No. 6,539,078.

The DBARC composition comprises a dye mixed in the composition or bonded to the acid-labile, photolabile or crosslinkable polymer. One of ordinary skill in the art would recognize that the terms “dye” and “chromophore” are sometimes used interchangeably. The dye is important to the performance of the DBARC. The dye provides the absorption necessary for the DBARC by absorbing at the exposure wavelength. By attenuating the light reflected from the substrate, the dye controls reflectivity that would otherwise degrade photoresist profiles. One potential advantage of having the dye be physically or chemically attached to the polymer, as opposed to being a free dye in the composition, is avoiding decomposition or sublimation of the free dye during baking of the DBARC.

One of ordinary skill in the art would know how to select a dye based on the requirements of the DBARC/resist system, e.g., the exposure wavelength and the DBARC polymer used. Non-limiting examples of dyes/chromophores include those described in US 2005/0214674, US 2006/0063105, U.S. Pat. No. 6,844,131 and references cited therein. US 2007/0117049 gives examples of dyes/chromophores that absorb at 248 nm and 193 nm.

Examples of crosslinkable polymers bonded to dyes/chromophores include, but are not limited to:
polymers derived from at least one monomer with a chromophore group and at least one monomer with a hydroxyl and/or a carboxyl group, as described in US 2005/0214674;
polymers derived from at least one monomer with an acid-labile group and at least one monomer with a chromophore, as described in U.S. Pat. No. 6,844,131; and
polymers derived from at least one monomer with a chromophore, as disclosed in US 2006/0063105.

In some embodiments, the amount of the acid-labile, photolabile or crosslinkable polymer in the DBARC composition is from about 40% to about 95% by weight relative to the solid portions of the composition. In other embodiments, the amount of the polymer is from about 45% to about 90%, or from about 50% to about 85% by weight of solids.

In further embodiments, the amount of the crosslinking agent in the DBARC composition is from about 5% to about 50% by weight of the solids of the composition. In certain embodiments, the amount of the crosslinking agent in the DBARC composition is from about 10% to about 45%, or from about 15% to about 40% by weight of solids.

Exposure of the photoresist/DBARC system to activating radiation leads to generation of the photoacid from the PAG in areas of the DBARC directly exposed or adjacent to the exposed areas of the photoresist (a layer of inert polymer can be between the DBARC and photoresist layers). The photoacid then catalyzes “deprotection reactions” in the DBARC—i.e., cleavage of the acid-labile groups or bonds of the acid-labile polymer, or cleavage of the acid-labile linkages formed between the crosslinkable polymer and the crosslinking agent, or cleavage of the photoreactive bonds in the backbone of the photolabile polymer.

After exposure of the resist/DBARC system to activating radiation, the system is baked to facilitate deprotection reactions in the DBARC and the resist. To minimize or prevent excessive lateral removal of the DBARC (i.e., undercut), however, it is critical to limit diffusion of the photoacid generated in the DBARC and that of any acid in the resist. Tuning of the post-exposure bake (PEB) temperature is important in controlling acid diffusion. Post-exposure baking at a temperature from 90° C. to 115° C. effectively limits acid diffusion through and between the DBARC and resist.

After the acid-labile groups or bonds, photoreactive bonds or acid-labile linkages of the polymeric DBARC, and those of the polymeric material forming the resist, have been cleaved, a base developer is used to solubilize and remove the exposed areas of the resist and the exposed areas of the DBARC. Typical base developers are basic aqueous solutions such as tetramethyl ammonium hydroxide and alkaline metal (e.g., potassium hydroxide) solutions.

Quencher

The quencher is also important to the performance of the DBARC and enhances the stability of the DBARC. The kind and the amount of quencher have an impact on the existence or amount of scumming and undercut of the DBARC, and are selected based on the features to be optimized. One or more quenchers can be used with the PAG to achieve good performance of the DBARC and low reflectivity. Moreover, the amount of quencher can be varied to achieve a target exposure radiation dose.

The photoacid-catalyzed deprotection reactions in the DBARC regenerate acidic protons that catalyze additional deprotection reactions, and so on, resulting in chemical amplification. To control chemical amplification, a basic quencher is employed.

The quencher is a basic compound that can be a photobase or a non-photobase. Quenchers are also called bases. Non-limiting examples of quenchers include photosensitive bases, amines, ammonium hydroxide, and those disclosed in U.S. Pat. No. 5,981,140 and EP 1041442. In some embodiments, optionally in combination with one or other embodiments described herein, the quencher is selected from ammonium hydroxide, tetrabutylammonium hydroxide, trimethylsulfonium hydroxide, triphenylsulfonium hydroxide, n-octylamine, trioctylamine, diethanolamine, triethanolamine, 1-piperidine ethanol, N,N-dimethylformamide, pyridine-3-carboxamide, imidazole, 2-phenylpyridine, 2-phenylbenzimidazole, N,N,N′,N′-tetrakis-2-hydroxypropyl(ethylenediamine), bis(t-butylphenyl)iodonium cyclamate, tris(t-butylphenyl)sulfonium cyclamate, and combinations thereof.

In some embodiments, optionally in combination with one or other embodiments described herein, the amount of the quencher in the DBARC composition is from about 10% to about 90% by weight of the PAG. In other embodiments, the quencher is in an amount from about 20% to about 80%, or from about 20% to about 60%, or from about 20% to about 40% by weight of the PAG.

Other Ingredients

Solvent systems that can be used for the DBARC composition of the invention can be any solvent system that dissolves, substantially dissolves, or disperses the components of the composition. Non-limiting examples of solvent systems include the solvents and solvent systems for DBARC compositions as disclosed in US 2005/0214674, US 2006/0063105, US 2006/0177772, US 2007/0117049, U.S. Pat. No. 7,108,958, U.S. Pat. No. 6,844,131 and WO 2004/046828.

In further embodiments, optionally in combination with one or more other embodiments described herein, the DBARC composition can comprise one or more additional ingredients to enhance the performance of the DBARC. In certain embodiments, the one or more additional ingredients are selected from catalysts, acids, thermal acid generators (TAGs), lower alcohols, surface leveling agents, surfactants, antifoaming agents, polymer binders, and adhesion promoters. The catalysts can be selected from acids, TAGs, and any other kinds of catalysts known to be useful in the lithographic process.

In some embodiments, the amount of an additional ingredient in the DBARC composition is from about 0.1% to about 30% by weight of the total solids of the composition. In certain embodiments, the amount of an additional ingredient in the DBARC composition is from about 0.1% to about 25%, or from about 0.1% to about 20%, or from about 0.1% to about 15%, or from about 0.1% to about 10%, or from about 0.1% to about 5% by weight of solids.

For shorter curing time, crosslinking between the crosslinkable polymer and the crosslinking agent can be accelerated by an acid or a TAG mixed in the DBARC composition. If the DBARC is crosslinked at elevated temperature, the TAG produces an acid upon heating. Acids or TAGs known to be useful for crosslinking polymers can be employed. However, strong free acids and strong acids liberated from TAGs can cause undercutting, the extent of which depends on the degree of lability of the crosslinkage to acid. Therefore, in certain embodiments, the acid or the thermal acid produced by the TAG is moderately acidic, having a pKa of about 1.0 or greater. In one embodiment, the acid or thermal acid has a pKa from about 1.0 to about 5.0. Non-limiting examples of acids and thermal acid generators include those disclosed in US 2005/0214674, US 2006/0177772, US 2007/0099108 and WO 2004/046828.

In some embodiments, the amount of the acid or the TAG in the DBARC compositions is from about 0.1% to about 25% by weight of solids. In narrower embodiments, the amount of the acid or the TAG in the DBARC composition is from about 0.1% to about 20%, or from about 0.1% to about 10%, or from about 0.1% to about 5% by weight of solids.

The DBARC composition can also comprise one or more other polymers or oligomers in addition to the acid-labile, photolabile or crosslinkable polymer, provided that the performance of the DBARC is not adversely affected. Non-limiting examples of other polymers include novolaks, polyhydroxystyrene, polymethylmethacrylate, polyarylates, and such polymers disclosed in US 2005/0214674. Further, the light-absorbing performance of the DBARC can be enhanced by using relatively low molecular weight compounds formed by reacting a carboxy-containing light-attenuating compound with a compound bearing multiple epoxy groups, as described in WO 2004/034435. In some embodiments, the amount of the additional polymers, oligomers or low molecular weight compounds in the DBARC composition is less than about 50%, or less than about 35%, or less than about 20%, or less than about 10% by weight of the total solids of the composition.

Structure Formed During Photolithography

Other embodiments of the invention, optionally in combination with one or more other embodiments described herein, are drawn to a structure formed during a photolithographic process. The structure of the invention comprises:
a substrate, and
a layer of wet developable bottom antireflective coating (DBARC) disposed over the substrate, wherein the coating is formed from any combination of embodiments of the inventive DBARC composition.

In yet other embodiments, optionally in combination with one or more other embodiments described herein, the structure further comprises a layer of photoresist disposed over the layer of DBARC. In one embodiment, the photoresist layer is directly adjacent to the DBARC layer. In another embodiment, the photoresist layer is separated from the DBARC layer by an intermediate layer of inert polymer that prevents intermixing of the photoresist and DBARC materials.

The underlying substrate of the structure can be any kind of substrate known to be useful in the electronics or semiconductor industry. For example, the substrate can be a silicon wafer. Moreover, the substrate can be of any design. For example, the substrate can be planar or can have topography (e.g., contacts or via holes, trenches, holes). The substrate can also be of any size or shape.

Further, the substrate can comprise any kind of material known to be useful in the electronics or semiconductor industry. In some embodiments, optionally in combination with one or more other embodiments described herein, the substrate comprises silicon, polysilicon, aluminum, germanium, tantalum, tungsten, aluminum/silicon alloy, tungsten silicide, gallium arsenide, tantalum nitride, silicon germanium, silicon oxide (including silicon dioxide), silicon nitride, silicon oxide nitride (or silicon(oxy)nitride), or a combination thereof. In further embodiments, the substrate can contain dielectric layers (e.g., silicon oxide), low k dielectric layers, and ion implant layers.

Method of Producing Positive Image

Further embodiments of the invention, optionally in combination with one or more other embodiments described herein, are directed to a photolithographic method for producing a positive, high-resolution image having substantially vertical profiles with substantially no scumming and substantially no undercut. The inventive method comprises:
applying any combination of embodiments of the inventive DBARC composition to a substrate under conditions to form a layer of cured, hardened or crosslinked wet developable bottom antireflective coating (DBARC) over the substrate, wherein the cured, hardened or crosslinked DBARC is substantially insoluble in photoresist solvents and substantially insoluble in base developing solutions prior to exposure to activating radiation;
forming a layer of positive photoresist over the DBARC layer to form a photoimageable system;
disposing a mask over the photoresist layer;
exposing the system to activating radiation;
baking the system at a temperature from 90° C. to 115° C. to facilitate deprotection reactions in the photoresist and DBARC; and
developing the system by contacting the photoresist layer and the DBARC layer with a base developing solution to remove the exposed areas of the photoresist layer and the exposed areas of the DBARC layer to produce a positive image on the substrate.

The DBARC composition of the invention can be used to form a DBARC over the substrate and below the positive photoresist in order to prevent reflections from the substrate onto the photoresist. Such reflections cause light interference, which in turn causes photoresist pattern degradation. The DBARC composition can be coated over the substrate using any technique known in the art, including dipping, spin coating and spraying.

Any combination of embodiments of the inventive DBARC composition described herein can be used to form the layer of DBARC over the substrate. For illustrative purposes, certain embodiments of the DBARC composition are reiterated below.

In some embodiments, the DBARC composition comprises:
an acid-labile polymer containing at least one acid-labile bond in its backbone or at least one acid-labile group, or
a photolabile polymer containing at least one photoreactive bond in its backbone, or
a crosslinkable polymer and a crosslinking agent, wherein the crosslinkable polymer contains a functional group capable of forming an acid-labile linkage with a functional group of the crosslinking agent;
a dye mixed in the composition or bonded to the acid-labile, photolabile or crosslinkable polymer;
a photoacid generator (PAG) containing an imide or methide anion and an onium cation, wherein the anion has a molar volume of about 145 cm³/mol or greater;
a quencher; and
a solvent system.

The PAG is of formula (I)

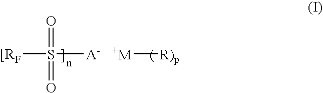

or of formula (II)

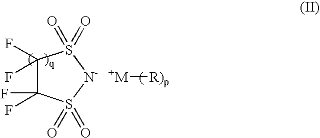

wherein:
A is N or C;
M is I or S;
each occurrence of R_{F} independently is straight or branched perfluoroalkyl or perfluorocycloalkyl, and optionally can have one or more substituents selected from straight or branched fluoroalkyl, straight or branched fluoroalkoxy, amino(fluoroalkyl), fluorocycloalkyl, fluoroheterocycloalkyl and fluoroaryl;
each occurrence of R independently is straight or branched alkyl, cycloalkyl, or aryl, and optionally can have one or more substituents selected from halogen atoms and straight or branched alkyl, straight or branched alkoxy, cycloalkyl, heterocycloalkyl, aryl, and acid-sensitive groups;
n is two when A is N and three when A is C;
p is two when M is I and three when M is S;
q is an integer from 1 to 4; and
the anion of the PAG of formula (I) or formula (II) has a molar volume of about 145 cm³/mol or greater.

In some embodiments, the anion of the PAG of formula (I) or formula (II) has a molar volume of at least about 160 cm³/mol, or at least about 175 cm³/mol, or at least about 200 cm³/mol, or at least about 225 cm³/mol, or at least about 250 cm³/mol.

In certain embodiments, the PAG is selected from diphenyliodonium, bis(4-t-butylphenyl)iodonium and triphenylsulfonium salts of bis(trifluoromethanesulfonyl)imide, bis(pentafluoroethanesulfonyl)imide, bis(nonafluorobutanesulfonyl)imide, tris(trifluoromethanesulfonyl)methide and cyclo(1,3-perfluoropropanedisulfone)imidate, and combinations thereof.

In a more specific embodiment, the PAG is selected from triphenylsulfonium and bis(4-t-butylphenyl)iodonium salts of bis(trifluoromethanesulfonyl)imide and tris(trifluoromethanesulfonyl)methide, and combinations thereof.

In an embodiment, the amount of the PAG in the DBARC composition is from about 0.1% to about 25% by weight of the acid-labile, photolabile or cross-linkable polymer. In another embodiment, the PAG is in an amount from about 1% to about 3% by weight of the acid-labile, photolabile or cross-linkable polymer.

In one embodiment, the DBARC composition comprises an acid-labile polymer containing at least one acid-labile bond in its backbone or at least one acid-labile group. In an embodiment, the at least one acid-labile bond or group is selected from orthoester, ketal, acetal, ester, thioester, anhydride, carbonate, sulfonamide, sulfonate, sulfate, imine, oxime, ether and thioether, and combinations thereof.

In another embodiment, the DBARC composition comprises a photolabile polymer containing at least one photoreactive bond in its backbone. In an embodiment, the photolabile polymer is a polycarbonate, polysulfonyl ester, polycarbonate-sulfone, polysulfonylester oxime, or polysulfonylester imine.

In yet another embodiment, the DBARC composition comprises a crosslinkable polymer and a crosslinking agent, wherein the crosslinkable polymer contains a functional group capable of forming an acid-labile linkage with a functional group of the crosslinking agent. In one embodiment, the linkage-forming functional group of the crosslinkable polymer is selected from carboxyl, hydroxyl, thiol and amino groups, and the linkage-forming functional group of the crosslinking agent is selected from vinyl ether, orthoester, ketal, acetal, ester, anhydride, carbonate, epoxy, and imine groups.

In certain embodiments, the quencher is selected from ammonium hydroxide, tetrabutylammonium hydroxide, trimethylsulfonium hydroxide, triphenylsulfonium hydroxide, n-octylamine, trioctylamine, diethanolamine, triethanolamine, 1-piperidine ethanol, N,N-dimethylformamide, pyridine-3-carboxamide, imidazole, 2-phenylpyridine, 2-phenylbenzimidazole, N,N,N′,N′-tetrakis-2-hydroxypropyl(ethylenediamine), bis(t-butylphenyl)iodonium cyclamate, tris(t-butylphenyl)sulfonium cyclamate, and combinations thereof.

In an embodiment, the amount of the quencher in the DBARC composition is from about 20% to about 80% by weight of the PAG. In another embodiment, the quencher is in an amount from about 20% to about 40% by weight of the PAG.

In some embodiments, the DBARC composition further comprises one or more additional ingredients selected from catalysts, acids, thermal acid generators, surfactants, polymer binders, and adhesion promoters.

The substrate coated with the DBARC composition of the invention can be any kind of substrate known to be useful in the electronics or semiconductor industry. For example, the substrate can be a silicon wafer. Further, the substrate can be of any design. For example, the substrate can be planar or can have topography (e.g., contacts or via holes, trenches, holes). The substrate can also comprise any kind of material known to be useful in the electronics or semiconductor industry. In some embodiments, optionally in combination with one or more other embodiments described herein, the substrate comprises silicon, polysilicon, aluminum, germanium, tantalum, tungsten, aluminum/silicon alloy, tungsten silicide, gallium arsenide, tantalum nitride, silicon germanium, silicon oxide (including silicon dioxide), silicon nitride, silicon oxide nitride (or silicon (oxy)nitride), or a combination thereof. In further embodiments, the substrate can contain dielectric layers (e.g., silicon oxide), low k dielectric layers, and ion implant layers.

The layer of cured, hardened or crosslinked DBARC can be formed over the substrate under conditions known to form a layer of cured, hardened or crosslinked antireflective coating over a substrate. For example, heat can be used to facilitate formation of a layer of cured, hardened or crosslinked DBARC over the substrate. Baking a coating of the composition over the substrate removes the solvent of the coating solvent system and cures or hardens the acid-labile or photolabile polymer or crosslinks the crosslinkable polymer and the crosslinking agent. In some embodiments, the baking temperature is in the range from about 70° C. to about 250° C., or from about 90° C. to about 230° C., or from about 110° C. to about 200° C. Baking below 70° C. may result in insufficient loss of solvent or insufficient amount of curing, hardening or crosslinking of the DBARC. Above 250° C., the DBARC may become chemically unstable.

The curing or crosslinking makes the DBARC substantially insoluble in both typical photoresist solvents (e.g., propylene glycol monomethyl ether acetate and ethyl lactate) and typical photoresist base developers (e.g., aqueous alkaline developing solutions). To maintain the integrity of the DBARC, the polymer of the cured, hardened or crosslinked DBARC is substantially insoluble in the solvent of the photoresist, which minimizes or prevents intermixing of the DBARC layer with the photoresist layer.

An intermediate layer of inert polymer can optionally be placed between the DBARC and photoresist layers to prevent intermixing of the latter two layers. Non-limiting examples of inert polymers include polysulfones and polyimides.

An acid can also be employed to catalyze crosslinkage between a crosslinkable polymer and a crosslinking agent. The acid can be added to the reaction system, be mixed in the DBARC composition, or be generated in situ from a thermal acid generator (TAG) by application of heat. Use of an acid or TAG can shorten the time for curing and crosslinking the DBARC. The TAG can be selected based, in part, on the temperature at which the TAG liberates the thermal acid. In some embodiments, the TAG is activated above 70° C., or above 90° C., or above 120° C., or above 150° C.

To avoid undercutting, a moderately acidic (e.g., pKa of about 1.0 or greater) acid or thermal acid produced by a TAG may be desired. To prevent cleavage of the acid-labile crosslinkages, it may also be desirable that none or very little of the acid or thermal acid remains in the DBARC once curing or crosslinking is complete. The acid or thermal acid can be selected such that it is eliminated from the layer of crosslinked DBARC. For example, after crosslinking occurs, the acid or thermal acid can be decomposed or volatilized by heat and the resulting decomposition products can be baked out of the DBARC, or the acid or thermal acid can sublime from the DBARC. In some embodiments, the acid or thermal acid is removed from the DBARC at a temperature from about 130° C. to about 220° C., or from about 150° C. to about 200° C.

A layer of positive photoresist is coated over the cured or crosslinked DBARC and baked to substantially remove the photoresist solvent. The photoresist can be any positive photoresist known to be effective for exposure at a particular desired wavelength or range of wavelengths. Examples of positive photoresists sensitive from about 300 nm to about 440 nm include those comprising a novolak resin and a quinone-diazide compound as the photoactive compound. The novolak resin can be prepared by condensing formaldehyde and one or more multi-substituted phenols in the presence of an acid catalyst (e.g., oxalic acid). The photoactive quinone-diazide compound can be made by reacting a multi-hydroxyphenolic compound with a naphthoquinone diazide acid or a derivative thereof.

Examples of photoresists sensitive between about 180 nm and about 300 nm include those comprising polyhydroxystyrene or a substituted derivative thereof, a photoactive compound and optionally a solubility inhibitor. Photoresists for 248 nm exposure are typically based on substituted polyhydroxystyrene derivatives and copolymers thereof. Non-limiting examples of photoresists sensitive in the 180-300 nm range, including at 248 nm, include those described in U.S. Pat. No. 4,491,628, U.S. Pat. No. 5,069,997 and U.S. Pat. No. 5,350,660.

Examples of photoresists sensitive below 200 nm (e.g., at 157 nm or 193 nm) include those comprising a non-aromatic polymer, a PAG and optionally a solubility inhibitor. Photoresists for exposure below 200 nm (e.g., at 193 nm) contain non-aromatic polymers since aromatic groups are opaque at low wavelengths. Such photoresists typically comprise polymers containing alicyclic hydrocarbons because they provide transparency at short wavelengths, their relatively high carbon to hydrogen ratios improve etch resistance (which was lost by eliminating aromatic functionalities from the polymer), and they have relatively high glass transition temperatures. Non-limiting examples of photoresists sensitive at 193 nm include those described in U.S. Pat. No. 6,723,488, U.S. Pat. No. 6,447,980, U.S. Pat. No. 5,843,624, U.S. Pat. No. 5,585,219, EP 794458, GB 2,320,718 and WO 97/33198.

Photoresists sensitive at 157 nm typically comprise fluorinated polymers with pendant fluoroalcohol groups and are substantially transparent at this wavelength. Non-limiting examples of such photoresists sensitive at 157 nm include those described in Tran et al., Macromolecules, 35: 6539 (2002); WO 00/67072; WO 00/17712; Kodama et al., Proc. SPIE, vol. 4690, p. 76 (2002); WO 02/065212; WO 01/98834; and EP 789278. Such fluorinated polymers can also be substantially transparent at 193 nm.

The photoresist coating normally is thicker than the DBARC. In some embodiments, optionally in combination with one or more other embodiments described herein, the layer of DBARC has a thickness in the range from about 10 nm to about 300 nm, or from about 20 nm to about 200 nm. In narrower embodiments, the thickness of the DBARC is from about 20 nm to about 150 nm, or from about 20 nm to about 100 nm, or from about 20 nm to about 75 nm, or from about 20 nm to about 50 nm. Since the DBARC is removed by exposure and development, the desired thickness of the DBARC can be determined by avoiding optical nodes where no light absorption is present in the DBARC. The DBARC can also have a thickness such that no standing waves are observed in the photoresist.

In some embodiments, the DBARC has a maximum thickness of λ/2n, where λ is the wavelength of the activating radiation and n is the refractive index of the DBARC. In certain embodiments, the DBARC has a maximum thickness of about 50 nm for exposure at 157 nm or 193 nm, about 70 nm for exposure at 248 nm, and about 120 nm for exposure at 350 nm. In other embodiments, the DBARC has a thickness greater than λ/2n. In certain embodiments, the DBARC has a thickness greater than 50 nm for exposure at 157 nm or 193 nm, greater than 70 nm for exposure at 248 nm, and greater than 120 nm for exposure at 350 nm.

The DBARC is photoimageable with the same wavelength of radiation as the photoresist. That is, the photoactive compounds in the photoresist and the DBARC absorb at the same exposure wavelength used to image the photoresist. The photoresist and DBARC are light-sensitive polymeric materials that undergo chemical changes after exposure to activating radiation. These chemical changes permit chemical differentiation between the exposed and unexposed areas of the photoresist and DBARC using a base developer. When a mask having a pattern of transmissive and reflective areas is employed, such chemical differentiation produces relief images. The produced images permit transfer of the image onto the underlying substrate (e.g., in semiconductor device manufacturing) or to other materials (e.g., in a printing process).

Device patterns are transferred to the resist in the exposure step through a mask. In a positive resist/DBARC system, raised patterns in the resist/DBARC are printed by opaque (0% transmission) patterns in the mask, and trenches in the resist/DBARC are printed by transparent (100% transmission) patterns in the mask. The areas surrounding the opaque features of the mask are transparent, and the areas surrounding the transparent features are opaque. Areas of the mask that are predominantly opaque, intended to print mostly trenches in the resist/DBARC, are called “dark field”, and the opposite for “bright field”. Semiconductor device manufacturing generally employs masks that contain both dark and bright fields.

Prior to exposure to activating radiation, both the resist and the DBARC are substantially insoluble in typical resist base developers. Exposure of the resist/DBARC system to activating radiation is a precursor step to deprotection reactions in the DBARC and resist. As explained earlier, exposure of the PAG in the DBARC to activating radiation generates the photoacid. The photoacid promotes deprotection reactions in the DBARC, resulting in cleavage of acid-labile groups, bonds or linkages in the exposed areas of the DBARC. Such cleavage renders the formerly insoluble DBARC soluble in and removable with base developers.

If the DBARC comprises a photolabile polymer containing one or more photoreactive bonds in its backbone, absorption of the exposure radiation by the chromophore of the polymer leads to chemical changes in and the breaking down of the photoreactive bonds. The light-activated photoreactive bonds can also react with an acid (e.g., the photoacid generated by the PAG that absorbs at the exposure wavelength), resulting in the breaking down of the bonds. The broken down polymeric products contain functional groups (e.g., sulfonic acid, hydroxyl, etc.) that render them soluble in a base developing solution.

Deprotection reactions in the resist can also be catalyzed by an acid. The acid in the resist can be pre-existing or generated in situ during the photolithographic process, e.g., from a thermal acid generator (TAG) by application of heat or from a PAG by application of light. The PAG in the resist can be the same or different than the PAG in the DBARC. In either case, the PAG in the resist absorbs at the same wavelength as the PAG in the DBARC during the exposure step. The acid, TAG or PAG can be included in the composition used to form the resist layer. Deprotection reactions in the resist also render the exposed areas of the resist soluble in base developers.

Alternatively, deprotection reactions in the resist need not be acid-catalyzed, but can be directly activated by the exposure radiation. For example, the exposure radiation can induce rearrangement reactions in the polymeric material of the resist that render the material soluble in a base resist developer. Unexposed areas of the resist would remain insoluble in the base developer due to, e.g., the crosslinked nature of the resist polymer.

In some embodiments, optionally in combination with one or more other embodiments described herein, the resist/DBARC system is exposed to radiation having a wavelength from about 100 nm to about 350 nm. In other embodiments, the system is exposed to deep ultraviolet (DUV) radiation, i.e., from about 100 nm to about 300 nm. In further embodiments, the resist/DBARC system is exposed to radiation from about 150 nm to about 250 nm. In certain embodiments, the system is exposed to radiation having a wavelength of 248 nm, or 193 nm, or 157 nm. In a particular embodiment, the activating radiation has a wavelength of 193 nm. DUV exposure technologies that have significantly advanced miniaturization in semiconductor device manufacturing use lasers emitting radiation at 248 nm, 193 nm or 157 nm.

After being exposed, the resist/DBARC system is baked at a temperature from 90° C. to 115° C. to facilitate deprotection reactions in the resist and DBARC. Heat promotes cleavage of acid-labile groups, bonds or linkages of the DBARC polymer in the presence of the photoacid generated in the exposed areas of the DBARC. Similarly, baking can facilitate cleavage of any acid-labile groups or bonds of the resist polymer in the exposed areas of the resist. Alternatively, baking can facilitate rearrangement reactions in the resist polymer that were induced by the exposure radiation.

To reduce or prevent excessive lateral removal of the DBARC (i.e., undercut), it is important to control diffusion of acid through and between the resist and DBARC, including diffusion of the photoacid generated in the DBARC and any acid present or generated in the resist. Besides the size of the photoacid, another way the method of the invention controls acid diffusion through and between the resist and DBARC is by controlling the post-exposure bake (PEB) temperature and the duration of the baking.

For the DBARC/resist system of the invention, post-exposure baking at a temperature from 90° C. to 115° C. effectively facilitates deprotection reactions and limits acid diffusion through and between the DBARC and resist, thereby minimizing or preventing scumming and undercut. If the PEB temperature is below 90° C., deprotection reactions proceed to an insufficient extent in the DBARC (and possibly in the resist), resulting in scumming. On the other hand, a PEB temperature above 115° C. leads to excessive diffusion of the photoacid generated in the DBARC and any acid generated in the resist through and between the DBARC and resist, resulting in undercut. In certain embodiments, the PEB temperature is from 90° C. to 110° C. In a specific embodiment, the PEB temperature is about 110° C.

The duration of post-exposure baking can be tuned based on the PEB temperature to reduce or eliminate scumming and undercut. In some embodiments, the post-exposure baking occurs for about 30 seconds to about 120 seconds. In other embodiments, the PEB step occurs for about 45 seconds to about 90 seconds, or for about 60 seconds to about 90 seconds. In a particular embodiment, the post-exposure baking occurs for about 60 seconds.

Since the exposed areas of the DBARC are developable with the same base developers typically used to develop the resist, exposure and wet development result in formation of a pattern in the resist and the DBARC. In other words, the base developer dissolves and removes the exposed areas of both the resist and the DBARC, thereby producing a positive image in the resist/DBARC system. The terms “wet development” and “wet developable” stem from the fact that typical resist developers are basic aqueous solutions.

The base developer used to develop the resist/DBARC system after exposure and baking can be any base developer known to wet develop resists and antireflective coatings. In some embodiments, optionally in combination with one or more other embodiments described herein, the base developer is a basic aqueous developing solution typically used to develop resists. In some embodiments, the base developer is an aqueous metal ion-free hydroxide solution. In certain embodiments, the metal ion-free hydroxide is a tetraalkylammonium hydroxide. In a particular embodiment, the base developer is aqueous tetramethylammonium hydroxide solution. In other embodiments, the base developer is an aqueous metal ion hydroxide solution. In certain embodiments, the metal ion hydroxide is an alkaline metal hydroxide. In a specific embodiment, the base developer is aqueous potassium hydroxide solution. The base developer can optionally contain one or more additives. Non-limiting examples of additives in base developers include surfactants, polymers, and lower alcohols (e.g., isopropanol and ethanol).

The solubility of the exposed areas of the DBARC in typical resist developers shortens the manufacturing process and reduces its cost by eliminating the need for a separate etch step to remove the antireflective coating. In contrast, dry development utilizes a high-energy plasma (typically oxygen) to remove the antireflective coating. The additional etch step lowers the throughput of the manufacturing process and increases its cost and the potential for device defects.

The photolithographic method of the invention, employing the inventive DBARC composition, produces high-resolution images on a substrate. Under the method, the resist/DBARC system can transfer features ≦130 nm or ≦100 nm from the mask to the substrate with a high degree of image edge acuity after exposure and wet development. The developed resist wall profiles are vertical or substantially vertical relative to the substrate, with no or substantially no scumming and undercut. The fine demarcations between exposed and unexposed areas of the resist/DBARC system translate into accurate pattern transfer of the mask image onto the substrate. Such accuracy is important as the miniaturization of critical components increasingly reduces dimensions on microelectronics and semiconductor devices.

All patent and non-patent literature referred to herein are incorporated herein by reference in their entirety.

### EXAMPLES

The examples set forth below are shown for the sole purpose of further illustrating embodiments of the present invention and are in no way meant to limit the invention. The following examples are given to aid in understanding the invention and to demonstrate the superior results achieved by the invention compared to conventional technology, but it is to be understood that the invention is not limited to the particular materials, procedures or conditions of the examples.

### Example 1

### Calculation of Molar Volume of Photoacids

The molar volume of various photoacids was calculated using the ACD ChemSketch 10.0 program available from Advance Chemistry Development, Inc. Chemical structures were drawn and the size of the photoacids was calculated in terms of molar volume. The molar volume of representative photogenerated acids, reported in units of cm³, is shown in Table 1.

TABLE 1
Molar volume of photoacids

| Photoacid | Molar Volume (±3 cm³) |
|---|---|
| (CF₃SO₂)₃CH | 207.2 |
| (CF₃SO₂)₂NH | 145.2 |
| (CF₃CF₂SO₂)₂NH | 200.1 |
| [CF₃(CF₂)₃SO₂]₂NH | 309.9 |

### Example 2

### Photolithography Using Novel DBARC Composition I and Resist I

To 10 ml of DBARC solution BSI.W06055B 07193.001JL (available from Brewer Science Inc., Rolla, Mo.) containing 0.1175 g of polymer and 0.0425 g of crosslinker and dye were added 2.065 mg of triphenylsulfonium tris(trifluoromethanesulfonyl)methide and 0.245 mg of 1-piperidine ethanol as quencher. The resulting DBARC solution was filtered through a 0.5 micron filter. A silicon wafer was coated with 550 Å of the DBARC solution prepared above and hard-baked at 160° C. for 60 seconds. Next, the DBARC-coated wafer was coated with 1950 Å of JSR ARX1682J photoresist (available from JSR Micro, San Jose, Calif.) and soft-baked at 110° C. for 60 seconds. The coated wafer was then exposed to 193 nm UV radiation through a binary chrome-on-glass mask using Nikon S305B scanner. After exposure the wafer was baked at 110° C. for 60 sec. and wet developed for 40 sec. using PD523 trimethylammonium hydroxide developer (available from Mosses Lake Industries, Inc.). Finally the patterns formed on the wafer were analyzed using Hitachi CD SEM (S9360). The dose used was 26 mJ/cm to print 140 nm space post-developed on wafer with a regular array of 140 nm space and 420 nm pitch on mask.

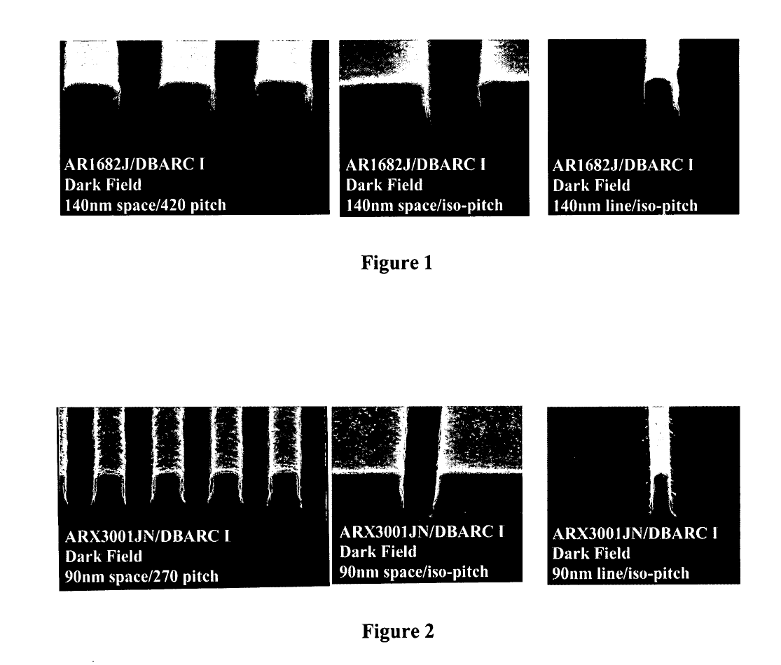

FIG. 1 displays scanning electron micrograph (SEM) images of 140S420P (1S:1.5 L, dark field), 140 isolated space (iso-space) in dark field, and 140 isolated line (iso-line). The SEM in FIG. 1 shows a cross-sectional view of both dark field and bright field patterns without scumming or undercut as a result of the use of novel DBARC composition I and resist I.

### Example 3

### Photolithography Using Novel DBARC Composition I and Resist II

To 10 ml of DBARC solution BSI.W06055B 07193.001JL (available from Brewer Science) containing 0.1175 g of polymer and 0.0425 g of crosslinker and dye were added 2.065 mg of triphenylsulfonium tris(trifluoromethanesulfonyl)methide and 0.245 mg of 1-piperidine ethanol as quencher. The resulting DBARC solution was filtered through a 0.5 micron filter. A silicon wafer was coated with 550 Å of the DBARC solution prepared above and hard-baked at 160° C. for 60 sec. Next the DBARC-coated wafer was coated with 1950 Å of JSR ARX3001JN photoresist (available from JSR Micro) and soft-baked at 110° C. for 60 sec. The coated wafer was then exposed to 193 nm UV radiation through a binary chrome-on-glass mask using Nikon S3057E scanner. After exposure the wafer was then baked at 110° C. for 60 sec. and wet developed for 40 sec. using PD523 developer from Mosses Lake Industries. Finally the patterns formed on the wafer were analyzed using Hitachi CD SEM (S9360). The dose used was 36 mJ/cm² to print 90 nm space post-developed on wafer with a regular array of 90 nm space and 270 nm pitch on mask.

FIG. 2 depicts SEM images of 90S270P (1S:2 L, dark field), 90 nm iso-space (dark field), and 140 iso-line (bright field). As can be readily seen from the cross-sectional view of the dark and bright field patterns in FIG. 2, the use of novel DBARC composition I and resist II results in both dark field and bright field patterns without scumming or undercut.

### Example 4

### Photolithography Using Novel DBARC Composition II and Resist I

To 10 ml of DBARC solution BSI.W06055B 07193.001JL (available from Brewer Science) containing 0.1175 g of polymer and 0.0425 g of crosslinker and dye were added 1.659 mg of triphenylsulfonium bis(trifluoromethanesulfonyl)imide and 0.245 mg of 1-piperidine ethanol as quencher. The resulting DBARC solution was filtered through a 0.5 micron filter. A silicon wafer was coated with 550 Å of the DBARC solution prepared above and hard-baked at 160° C. for 60 sec. Next the DBARC-coated wafer was coated with 1950 Å of JSR ARX1682J photoresist (available from JSR Micro) and soft-baked at 110° C. for 60 sec. The coated wafer was then pattern-wise exposed to 193 nm UV radiation through a binary chrome-on-glass mask using Nikon S305B scanner. After exposure the wafer was then baked at 110° C. for 60 sec. and wet developed for 40 sec. using PD523 developer from Mosses Lake Industries. Finally the patterns formed on the wafer were analyzed using Hitachi CD SEM (S9360). The dose used was 26 mJ/cm² to print 140 nm space post-developed on wafer with a regular array of 140 nm space and 420 nm pitch on mask.

FIG. 4(b) exhibits SEM images of 140S420P (1S:1.5 L, dark field), 140 iso-space (dark field), and 140 iso-line (bright field). The top-down SEM in FIG. 4(b) shows that the use of novel DBARC composition II and resist I results in no pattern collapse of dark field and bright field features.

### Example 5

### Photolithography Using Coventional DBARC Composition III and Resist I

A silicon wafer was coated with 550 Å of DBARC solution BSI.W06055 (available from Brewer Science), used without any modification, and hard-baked at 160° C. for 60 sec. Next the DBARC-coated wafer was coated with 1950 Å of JSR ARX1682J photoresist (available from JSR Micro) and soft-baked at 110° C. for 60 sec. The coated wafer was then exposed to 193 nm UV radiation through a binary chrome-on-glass mask using Nikon S305B scanner. After exposure the wafer was baked at 110° C. for 60 sec. and wet developed for 40 sec. using PD523 developer from Mosses Lake Industries. Finally the wafer was analyzed using Hitachi CD SEM (S9360). The dose used was 26 mJ/cm² to print 140 nm space post-developed on wafer with a regular array of 140 nm space and 420 nm pitch on mask.

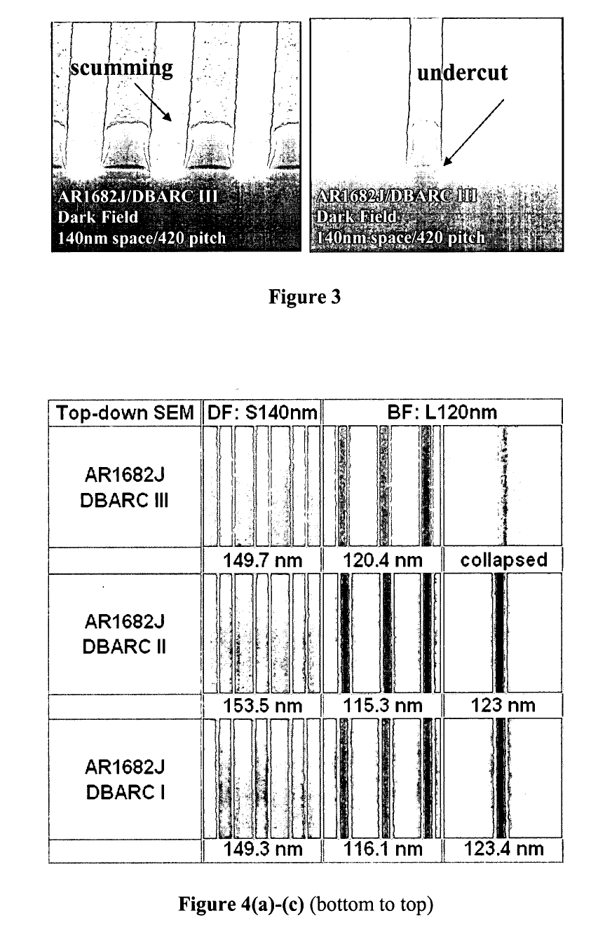

FIG. 3 depicts SEM images of 140S420P (1S:1.5 L, dark field) and 140 iso-line (bright field). The cross-sectional view of both dark field and bright field patterns in FIG. 3 demonstrates that the use of conventional DBARC composition III and resist I results in both scumming and undercut. At 26 mJ/cm², dark field trench features show scumming and bright field patterns show undercutting.

FIGS. 4(a)-(c) compare the results of photolithography using the same resist I (AR1682J) and novel DBARC composition I, novel DBARC composition II, and conventional DBARC composition III, respectively, under identical processing conditions. The SEM images in FIGS. 4(a)-(c) represent top-down comparison of dark field (DF) and bright field (BF) features achieved by these three resist/DBARC systems. In sharp contrast to FIGS. 4(a) and (b) for novel DBARC compositions I and II, FIG. 4(c) clearly demonstrates that the use of conventional DBARC composition III causes pattern collapse for isolated resist lines.

While particular embodiments of the present invention have been shown and described, it will be apparent to those skilled in the art that changes and modifications can be made thereto without departing from the invention in its broader aspects. Therefore, the appended claims are to encompass within their scope all such changes and modifications as fall within the true spirit and scope of the present invention.

What is claimed is:

1. A method for producing a positive, high-resolution image having substantially vertical profiles with substantially no scumming and substantially no undercut, the method comprising:
applying a composition to a substrate to form a layer of crosslinked wet developable bottom antireflective coating (DBARC) over the substrate;
forming a layer of positive photoresist over the DBARC layer to form a photoimageable system;
exposing the system to activating radiation; and
baking the system at a temperature from 90° C. to 115° C.;
wherein the composition comprises:
a crosslinkable polymer and a crosslinking agent, wherein the crosslinkable polymer contains a functional group capable of forming an acid-labile linkage with a functional group of the crosslinking agent;
a dye mixed in the composition or bonded to the cross-linkable polymer; and
a photoacid generator (PAG) of formula (I) 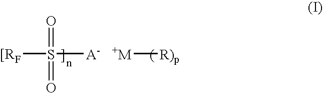
or of formula (II) 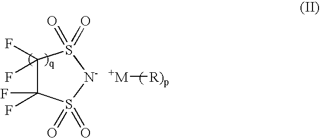
wherein:
A is N or C;
M is I or S;
each occurrence of R_{F} independently is straight or branched perfluoroalkyl or perfluorocycloalkyl, and optionally can have one or more substituents selected from straight or branched fluoroalkyl, straight or branched fluoroalkoxy, amino(fluoroalkyl), fluorocycloalkyl, fluoroheterocycloalkyl and fluoroaryl;
each occurrence of R independently is straight or branched alkyl, cycloalkyl, or aryl, and optionally can have one or more substituents selected from halogen atoms and straight or branched alkyl, straight or branched alkoxy, cycloalkyl, heterocycloalkyl, aryl, and acid-sensitive groups;
n is two when A is N and three when A is C;
p is two when M is I and three when M is S;
q is an integer from 1 to 4; and
the anion of the PAG of formula (I) or formula (II) has a molar volume of about 145 cm³/mol or greater.

2. The method of claim 1, wherein the crosslinked DBARC is substantially insoluble in photoresist solvents and substantially insoluble in base developing solutions prior to exposure to the activating radiation.

3. The method of claim 1, wherein the linkage-forming functional group of the crosslinkable polymer is selected from carboxyl, hydroxyl, thiol and amino groups, and the linkage-forming functional group of the crosslinking agent is selected from vinyl ether, orthoester, ketal, acetal, ester, anhydride, carbonate, epoxy, and imine groups.

4. The method of claim 1, wherein the dye absorbs at the wavelength of the activating radiation.

5. The method of claim 1, wherein the anion of the PAG of formula (I) or formula (II) has a molar volume of about 175 cm³/mol or greater.

6. The method of claim 5, wherein the anion of the PAG of formula (I) or formula (II) has a molar volume of about 200 cm³/mol or greater.

7. The method of claim 1, wherein the PAG is selected from:
diphenyliodonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
bis(4-t-butylphenyl)iodonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
triphenylsulfonium salts of bis(trifluoromethanesulfonyl)imide, bis(pentafluoroethanesulfonyl)imide, bis(nonafluorobutanesulfonyl)imide, tris(trifluoromethanesulfonyl)methide, and cyclo(1,3-perfluoropropanedisulfone)imidate;
and combinations thereof.

8. The method of claim 7, wherein the PAG is selected from bis(4-t-butylphenyl)iodonium bis(trifluoromethanesulfonyl)imide, bis(4-t-butylphenyl)iodonium tris(trifluoromethanesulfonyl)methide, triphenylsulfonium bis(trifluoromethanesulfonyl)imide, triphenylsulfonium tris(trifluoromethanesulfonyl)methide, and combinations thereof.

9. The method of claim 1, wherein the PAG is in an amount from about 0.1% to about 25% by weight of the cross-linkable polymer.

10. The method of claim 9, wherein the PAG is in an amount from about 1% to about 3% by weight of the cross-linkable polymer.

11. The method of claim 1, wherein the composition further comprises a quencher.

12. The method of claim 11, wherein the quencher is selected from ammonium hydroxide, tetrabutylammonium hydroxide, trimethylsulfonium hydroxide, triphenylsulfonium hydroxide, n-octylamine, trioctylamine, diethanolamine, triethanolamine, 1-piperidine ethanol, N,N-dimethylformamide, pyridine-3-carboxamide, imidazole, 2-phenylpyridine, 2-phenylbenzimidazole, N,N,N′,N′-tetrakis-2-hydroxypropyl(ethylenediamine), bis(t-butylphenyl)iodonium cyclamate, tris(t-butylphenyl)sulfonium cyclamate, and combinations thereof.

13. The method of claim 11, wherein the quencher is in an amount from about 20% to about 80% by weight of the PAG.

14. The method of claim 13, wherein the quencher is in an amount from about 20% to about 40% by weight of the PAG.

15. The method of claim 1, wherein the composition further comprises one or more additional ingredients selected from catalysts, acids, thermal acid generators, surfactants, polymer binders, and adhesion promoters.

16. The method of claim 1, wherein the composition further comprises a solvent system.

17. The method of claim 1, further comprising disposing a mask over the photoresist layer prior to exposing the system to activating radiation.

18. The method of claim 1, wherein the activating radiation is deep ultraviolet radiation having a wavelength of 248 nm, 193 nm or 157 nm.

19. The method of claim 18, wherein the activating radiation has a wavelength of 193 nm.

20. The method of claim 1, wherein the post-exposure baking temperature is from 90° C. to 110° C.

21. The method of claim 1, wherein the post-exposure baking temperature is about 110° C.

22. The method of claim 1, wherein the post-exposure baking occurs for about 45 seconds to about 90 seconds.

23. The method of claim 1, further comprising developing the system after post-exposure baking by contacting the photoresist layer and the DBARC layer with a base developing solution to remove the exposed areas of the photoresist layer and the exposed areas of the DBARC layer to produce a positive image on the substrate.

24. The method of claim 23, wherein the base developing solution is selected from aqueous tetramethyl ammonium hydroxide solution and aqueous alkaline metal hydroxide solutions.

25. The method of claim 1, wherein the substrate comprises silicon, polysilicon, aluminum, germanium, tantalum, tungsten, tungsten silicide, gallium arsenide, tantalum nitride, silicon germanium, silicon oxide, silicon nitride, silicon oxide nitride, or a combination thereof.
